(19) United States
(12) Patent Application Publication
(10) Pub. No.: US 2024/0181915 A1
(43) Pub. Date: Jun. 6, 2024

(54) CONTROL BOX FOR CHARGING

(71) Applicants: HYUNDAI MOTOR COMPANY, Seoul (KR); KIA CORPORATION, Seoul (KR); Kyungshin Corp., Incheon (KR)

(72) Inventors: Yun Jae Jung, Suwon-si (KR); Jeong Woo Hwang, Incheon (KR); Hyuck Lee, Incheon (KR); Su Ji Choi, Incheon (KR)

(73) Assignees: HYUNDAI MOTOR COMPANY, Seoul (KR); KIA CORPORATION, Seoul (KR); Kyungshin Corp., Incheon (KR)

(21) Appl. No.: 18/197,801

(22) Filed: May 16, 2023

(30) Foreign Application Priority Data
Dec. 5, 2022 (KR) 10-2022-0167907

(51) Int. Cl. B60L 53/62; B60L 53/18; B60L 53/66

(52) U.S. Cl. CPC B60L 53/62; B60L 53/18; B60L 53/66; B60L 2210/22

(57) ABSTRACT

A control box for charging includes: a first connector connected to a supply cable having a plug, which is connected to an external power source, at a first end, and having a plurality of connection pins; and a control board having a first switch mounted therein and configured to control the first switch in a first state such that an input signal is transmitted to an output terminal of the control box when power is supplied in a first mode in which a signal is input from the first connector. In particular, the control board is configured to control the first switch in a second state to transmit and receive signals to and from a vehicle connected to the output terminal when power is supplied in a second mode in which a signal is not input from the first connector.

### CROSS-REFERENCE TO RELATED APPLICATION

The present application claims priority to Korean Patent Application No. 10-2022-0167907, filed Dec. 5, 2022, the entire contents of which are incorporated herein by reference.

### BACKGROUND

### Technical Field

The present disclosure relates to a control box for charging that monitors and controls the SOC (State of Charge) when the battery of an electrified vehicle is charged and that has a structure that is compatible with a plurality of charging cables according to external power sources.

### Description of the Related Art

Since an electrified vehicle uses a battery in the vehicle as a main power source, it is required to secure power of the battery. The battery can be charged with electrical energy generated in the vehicle or electrical energy provided by an external power source.

When power of a battery is secured by electrical energy of an external power source, different types of charging methods can be applied to an electrified vehicle, depending on the kind of external power source providing electrical energy. For example, it is possible to charge a battery by connecting an electrified vehicle to a system power source for home or industrial use or a charging facility (Electric Vehicle Supply Equipment (EVSE), and the like). There is a difference in that power is always supplied from a system power source when only a plug is connected to a socket, but a control signal related to charging is not directly provided, whereas power is supplied from a charging facility through exchange of control signals.

Accordingly, electrified vehicles should be equipped with a charging cable suitable for a charging environment to charge a battery due to these different charging types. For example, charging cables that are used to charge a battery through a system power source may include an In-Cable Control Box (ICCB) that monitors and controls an SOC. Meanwhile, charging cables that are used to charge a battery through a charging facility may have a plug supposed to be connected to an external power source and a plug supposed to be connected to a vehicle at both ends, respectively.

In order to use both of the different charging types described above when charging a battery, users of electrified vehicles need a plurality of charging cables corresponding to the types, respectively, which results in an economic burden.

The description provided above as a related art of the present disclosure is just for helping understand the background of the present disclosure and should not be construed as being included in the related art known by those having ordinary skill in the art.

### SUMMARY

The present disclosure has been made in an effort to solve these problems and an objective of the present disclosure is to provide a control box for charging that monitors and controls the SOC when the battery of an electrified vehicle is charged and that has a structure that is compatible with a plurality of charging cables according to external power sources.

The technical subjects to implement in the present disclosure are not limited to the technical problems described above and other technical subjects that are not stated herein should be clearly understood by those having ordinary skill in the art from the following specifications.

In order to achieve the objectives described above, a control box for charging according to the present disclosure includes: a first connector connected to a supply cable having a plug, which is connected to an external power source, at a first end, and having a plurality of connection pins; and a control board. The control board has a first switch mounted therein and is configured to: control the first switch in a first state such that an input signal is transmitted to an output terminal of the control box for charging when power is supplied in a first mode in which a signal is input from the first connector. The control board is configured to control the first switch in a second state to transmit and receive signals to and from a vehicle connected to the output terminal when power is supplied in a second mode in which a signal is not input from the first connector.

In one embodiment, the control box for charging may further include an output cable connected to the output terminal and configured to output power and signals provided through the supply cable to the vehicle.

The first mode may be a mode in which the plug of the supply cable is connected to a charging facility, and the second mode may be a mode in which the plug of the supply cable is connected to a system power source.

In one embodiment, the first switch may include: a first terminal connected to the first connector; a second terminal connected to the control board; and a third terminal connected to the output terminal.

In one embodiment, the control board may control the first switch in the first state in which the first terminal and the third terminal are connected when power is supplied in the first mode in which the signal is input from the first connector. The control board may control the first switch in the second state in which the second terminal and the third terminal are connected when power is supplied in the second mode in which the signal is not input from the first connector.

In one embodiment, when power is supplied in the first mode, at least one first power pin corresponding to the first mode of the plurality of connection pins of the first connector may be directly connected to the output terminal.

In another embodiment, when power is supplied in the second mode, at least one second power pin corresponding to the second mode of the plurality of connection pins of the first connector may be connected to the control board, and the control board may further include a second switch connected to the at least one second power pin and the output terminal at both ends, respectively.

In one embodiment, when power is supplied in the second mode, the control board may control the second switch in an open state until a signal is input from the vehicle by controlling the first switch in the second state, and may control the second switch in a close state when a signal is input from the vehicle.

In one embodiment, the first connector may have at least one recognition pin connected to the supply cable and configured to recognize the resistance of the plug of the plurality of connection pins, and when the control board is connected to the at least one connection pin and is supplied with power in the second mode, the control board may control the second switch based on the recognized resistance of the plug.

In one embodiment, when power is supplied in the second mode, the control board may determine an allowable current of the plug based on a determined voltage according to the recognized resistance of the plug and a pre-stored resistance of the plug and may control the second switch in the open state when a supply current corresponding to power that is supplied exceeds the allowable current of the plug.

In one embodiment, the control board may include at least one of a current transformer and a zero-phase current transformer that are configured to measure a supply current corresponding to power that is supplied.

In one embodiment, the control board may further include: a second connector disposed between the second power pin and the second switch; and a third connector disposed between the second switch and the output terminal.

According to the control box for charging of the present disclosure, the control box for charging is connected to a plurality of supply cables according to external power sources and forms transmission paths for power and signals for a plurality of modes, thereby controlling charging of a vehicle. Accordingly, it is possible to increase compatibility according to a plurality of modes.

Further, since the control box for charging forms transmission paths for power and signals for a plurality of modes and controls charging of a vehicle, there is no need for carry chargers corresponding to a plurality of modes, respectively, so it is possible to secure convenience for users.

The effects of the present disclosure are not limited to the effects described above and other effects can be clearly understood by those having ordinary skill in the art from the following description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view showing a separation type charger having a control box for charging according to an embodiment of the present disclosure; and

FIGS. 2 and 3 are views showing transmission paths for power and signals in a plurality of modes in the control box for charging according to an embodiment of the present disclosure.

### DETAILED DESCRIPTION

In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first,” “second,” and the like may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Singular forms are intended to include plural forms unless the context clearly indicates otherwise.

It should be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

Hereafter, embodiments of the present disclosure are described in detail with reference to the accompanying drawings, and the same or similar components are given the same reference numerals regardless of the numbers of figures and are not repeatedly described.

When a component, device, element, or the like, of the present disclosure, is described as having a purpose or performing an operation, function, or the like, the component, device, or element should be considered herein as being “configured to” meet that purpose or to perform that operation or function.

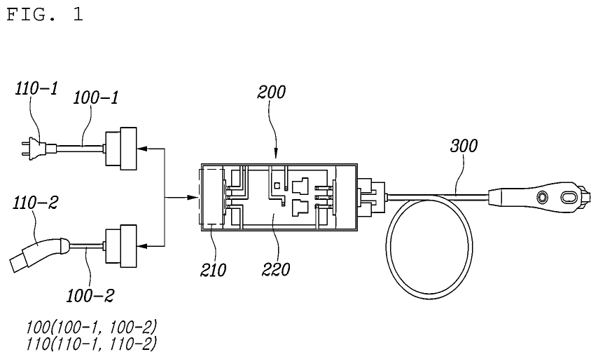

First, a separation type charger employing a control box for charging according to an embodiment of the present disclosure is described with reference to FIG. 1.

FIG. 1 is a view showing a separation type charger having a control box for charging according to an embodiment of the present disclosure.

Referring to FIG. 1, a separation type charger may include: a supply cable 100 that is connected to an external power source and supplies power; a control box for charging 200 that charges a vehicle with the power supplied through the supply cable 100 and monitors or controls the SOC; and an output cable 300 that is connected a vehicle to provide power provided through the supply cable 100 to the vehicle. The components are described hereafter.

The supply cable 100 is connected to an external power source, thereby being able to provide power. To this end, a plug 110 that is connected to an external power source may be disposed at a first end of the supply cable 100. The plug 110 may include a resistor 111 for determining a current flowing through the plug 110 or a voltage at the plug 110 when the plug 110 is connected to an external power source.

The kinds of external power sources that are connected to the supply cable 100 may be varied, depending on charging types, and the plug 110 may also be provided in various ways. In one embodiment, the supply cable 100 may include a supply cable 100-1 that is connected to a socket for providing system power for home or commercial use, and a supply cable 100-2 that is connected to a charging facility (e.g., Electric Vehicle Supply Equipment (EVSE)). A plug 110-1 that is connected to a socket for home or commercial use may be disposed at a first end of the supply cable 100-1 that is used when an external power source is a system power source such as for home or commercial use, and a plug 110-2 that is connected to a charging facility may be disposed at a first end of the supply cable 100-2 that is used when an external power source is a charging facility.

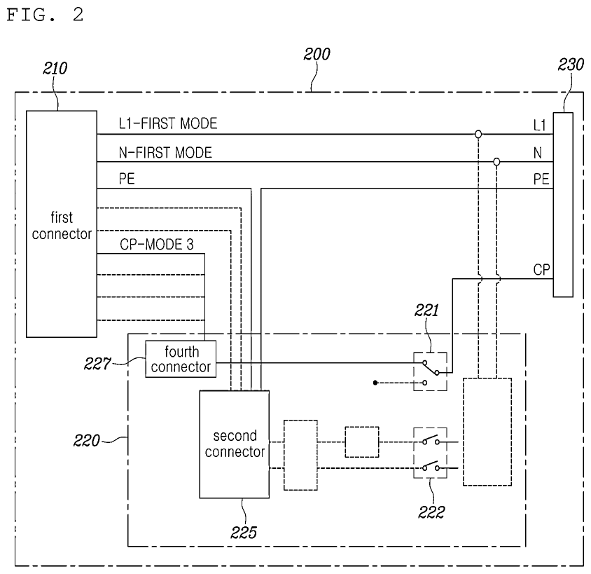

The control box for charging 200 may include a first connector 210, a control board 220, and an output terminal 230. FIGS. 1-2 mainly show components related to an embodiment of the present disclosure, and of course, actually fewer or more components may be included to implement the control box 200.

When the supply cable 100-1 that is connected to a system power source is connected to the control box 200, power is provided but signals may not be provided. However, when the supply cable 100-2 that is connected to a charging faculty is connected to the control box 200, power and signals can be provided. Accordingly, the control box 200 may transmit a provided signal intact or may generate and provide signals, depending on the connected supply cable 100.

The control box for charging 200 may have a first connector 210 for connection with a plurality of supply cables 100-1 and 100-2. The first connector 210 can be coupled to and separated from any one of the supply cables 100-1 and 100-2, depending on charging types. The first connector 210 may have a plurality of connection pins (not shown) for connection with the supply cable 100. The connection pins may include a connection pin that recognizes power and a connection pin that recognizes signals to recognize power and signals that are provided through the supply cables 100-1 and 100-2.

The control box 200 can monitor or control the SOC in a vehicle when the vehicle is charged with power provided through the supply cable 100. For example, the control box 200 can monitor or control the SOC in a vehicle and can also function as an intermediate path for transmitting provided power, depending on the supply cable 100 connected to the first connector 210.

When the control box 200 is connected to the supply cable 100-1 that is connected to a terminal for home or commercial use, power input from the terminal for home or commercial use can be intact transmitted through the supply cable 100-1 and then provided to a vehicle through the control box 200. In this case, there may be a need for a device that adjusts and controls power that is provided through the supply cable 100, and the control box 200 can perform the function. To this end, the control box 200 according to an embodiment of the present disclosure may be implemented as an In-Cable Control Box (ICCB).

However, when the control box 200 is connected to the supply cable 100-2 that is connected to a charging facility, input power can be adjusted and charging can be generally controlled by checking the state of a vehicle using the charging facility. In this case, the control box 200 may be disposed of between the supply cable 100-2 and the vehicle and may function as a path for transmitting/receiving power or signals.

As described above, since the control box 200 has the first connector 210 at the first end, it is possible to cope with a plurality of external power sources using one control box for charging 200, but the function that is performed by the control box 200 may depend on the connected supply cable 100 of the supply cables 100-1 and 100-2. To this end, the control box 200 may include a control board 220 that changes functions that are performed by the control box 200 in accordance with the supply cable 100 that is connected.

The control board 220 may be disposed of in the control box 200 and may be connected to the first connector 210. The control board 220 can recognize to which external power source the supply cable 100 connected to the first connector 210 is connected, and the control board 220 can perform control such that transmission paths for power and signals, which are input through the first connector 210, are formed in different ways.

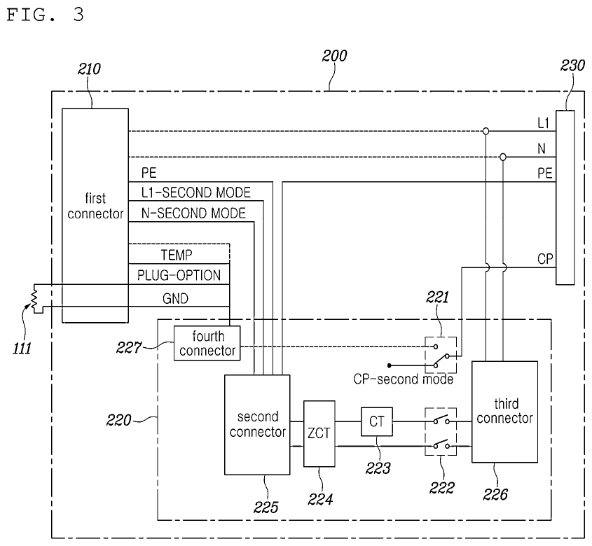

In detail, the control board 220 can form different transmission paths in accordance with the case in which power is supplied in a first mode in which signals are input from the first connector 210 and the case in which power is supplied in a second mode in which signals are not input from the first connector 210. The first mode in which signals are input from the first connector 210 may mean the state in which the plug 110 of the supply cable 100 connected to the control box 200 is connected to a charging facility, and the second mode in which signals are not input from the first connector 210 may mean the state in which the plug 110 of the supply cable 100 connected to the control box for charging 200 is connected to a terminal for home or commercial use. Controlling by the control board 220 according to a plurality of modes is described below with reference to FIGS. 2 and 3.

When the control board 220 is implemented, the control board 220 according to an embodiment of the present disclosure may be implemented as a Printed Circuit Board (PCB) type. However, this is only an example and the control board 220 is not limited thereto. For example, the control board 220 may be separated from a PCB and a Micro Controller Unit (MCU) mounted on a PCB may perform the function.

Meanwhile, the control box for charging 200 may have, at a second end thereof, an output terminal 230 through which power and signals input through the first connector 210 are output. Further, an output cable 300 for outputting power and signals provided through the supply cable 100 to a vehicle may be connected to the output terminal 230 of the control box for charging 200. It is assumed that the output cable 300 according to an embodiment of the present disclosure is always connected to the output terminal of the control box for charging 200. However, this is only an example and the present disclosure is not limited to this structure. For example, the output cable 300 may be connected to and separated from the control box for charging 200 through a connection device (not shown), similar to the supply cable 100, by providing the connection device at the output terminal 230 of the control box 200.

Hereafter, the control board 220 that forms transmission paths for power and signals, which are input through the first connector 210, in different ways in accordance with a plurality of modes is described in detail with reference to FIGS. 2 and 3.

FIGS. 2 and 3 are views showing transmission paths for power and signals in a plurality of modes in the control box for charging according to an embodiment of the present disclosure.

Before describing FIGS. 2 and 3, a plurality of connection pins (not shown) may be formed at the first connector 210 of the control box for charging 200 and the plurality of connection pins may perform different functions, respectively. Different connection pins of the plurality of connection pins may be used in accordance with power and signals that are provided from the supply cable 100 connected to the first connector 210. However, this is only an example, and of course, the plurality of connection pins formed at the first connector 210 are not limited to the configuration described above.

Configurations that are used in accordance with respective modes are indicated by solid lines and configurations that are not used are indicated by dotted lines to discriminate different transmission paths for power and signals in a plurality of modes.

Referring to FIGS. 2 and 3, the control board 220 may have a first switch 221 and can form different transmission paths for power and signals input through the first connector 210 by controlling the first switch 221.

Control by the control board 220 according to the first mode is described first with reference to FIG. 2. Referring to FIG. 2, when power is supplied in a first mode in which signals are input from the first connector 210, the control board 220 can control the first switch 221 in a first state such that an input signal is transmitted to the output terminal 230 of the control box for charging 200.

The first switch 221 may include a first terminal connected to the first connector 210, a second terminal connected to the control board 220, and a third terminal connected to the output terminal 230. The first terminal can be connected to a connection pin that recognizes signals, that is, a connection pin that recognizes a communication signal of the signals of the plurality of connection pins formed at the first connector 210 when it is connected to the first connector 210. The communication signal may be a Control Pilot (CP) communication signal that is transmitted between a vehicle and the controller of a charging facility. When power is supplied in the first mode, charging of a vehicle may be controlled by a charging facility that provides power, and a CP communication signal generated by the charging facility can be transmitted to the vehicle through the control box for charging 200 or a CP communication signal generated by the vehicle can be transmitted to the charging facility through the control box for charging 200. To this end, the control board 220 can control the first switch 221 in the first state in which the first terminal and the third terminal of the first switch 221 are connected to each other.

When the control board 220 controls the first switch 221 such that a CP communication signal corresponding to the first mode and input from the first connector 210 is transmitted to the output terminal 230, a charging facility can transmit and receive a CP communication signal to and from a vehicle through a transmission path formed in the control box 200 to check the SOC in the vehicle. When the vehicle enters a charging-possible state, power supplied in the first mode can be transmitted to the vehicle to charge the vehicle.

When power is supplied in the first mode, at least one first power pin corresponding to the first mode of the plurality of connection pins of the first connector 210 is directly connected to the output terminal 230, whereby the supply power can be transmitted to a vehicle. According to the above description, the first mode may be a case in which power is supplied through a charging facility and the second mode may be a case in which power is supplied through a terminal for home or commercial use. Accordingly, the current corresponding to the power that is supplied in the first mode may be larger than the current corresponding to the power that is supplied in the second mode.

Accordingly, when the power supplied in the first mode is transmitted to the output terminal 230 through the control board 220 or a PCB (not shown) disposed of in the control box 200, the size of the control board 220 or the PCB may be increased due to flow of the large current and heat may be generated at the control board 220 or the PCB. Since this may influence the durability and safety of the control box 200, power that is supplied is made be transmitted directly to the output terminal 230 in the first mode in which a current larger than the current in the second mode flows, whereby it is possible to secure durability and safety of the control box for charging 200. For example, at least one first power pin corresponding to the first mode may be connected to a line L1, which is an output line corresponding to the first mode, and a line N, which is a neutral line corresponding to the first mode.

When power is supplied in the first mode in which signals are input from the first connector 210, the control box for charging 200 functions as a cable that merely connects the supply cable 100 and the output cable 300 to each other, thereby being able to transmit the power that is supplied in the first mode to a vehicle.

Hereafter, control by the control board 220 according to the second mode is described with reference to FIG. 3.

Referring to FIG. 3, when power is supplied in the second mode in which signals are not input from the first connector 210, the control board 220 can control the first switch 221 in a second state to transmit and receive signals to and from a vehicle connected to the output terminal 230. According to the above description, the first switch 221 may include the first terminal connected to the first connector 210, the second terminal connected to the control board 220, and the third board connected to the output terminal 230.

In the second mode, power can be supplied through a connection with a terminal for home or commercial use, and unlike the first mode, there is no controller that controls charging of a vehicle in charging. It is required to adjust power that is provided to a vehicle by checking the SOC in the vehicle when the vehicle is connected to an external power source and charged, and there is a possibility of poor charging or overcharging of the vehicle unless the power is adjusted. Accordingly, the control board 220 can function as a controller that controls charging of a vehicle when power is supplied in the second mode. To this end, when power is supplied in the second mode, the control board 220 can control the first switch 221 in a second state in which the second terminal and the third terminal of the first switch 221 are connected.

The control board 220 can make signals be transmitted and received between the control board 220 and a vehicle by controlling the first switch 221. The signals that are transmitted and received in this case may be CP communication signals for checking the SOC in a vehicle in correspondence to the second mode. The control board 220 can check the SOC in the vehicle based on the CP communication signal, and can transmit the power supplied in the second mode to the vehicle to charge the vehicle when the vehicle enters a charging-possible state. However, the power that is supplied in the second mode can be transmitted to the vehicle through the control board 220.

In detail, when power is supplied in the second mode, at least one second power pin corresponding to the second mode of the plurality of connection pins of the first connector 210 is directly connected to the control board 220, whereby the supply power can be transmitted to a vehicle through the control board 220. For example, at least one second power pin corresponding to the second mode may be connected to a line L1, which is an output line corresponding to the second mode, and a line N, which is a neutral line corresponding to the second mode.

The control board 220 further includes a second switch 222 and the second power pin and the output terminal 230 may be connected to both ends of the second switch 222, respectively. The control board 220 may or may not charge a vehicle with the power supplied in the second mode by controlling the second switch 222.

The second switch 222 can be always maintained in an open state to prevent power that is provided through the connection cable 100 from being directly transmitted to the output terminal 230 when the supply cable 100 is connected to the first connector 210. Accordingly, when power is supplied in the second mode, the control board 220 controls the first switch 221, whereby the second switch 222 can be always maintained in an open state before signals are transmitted and received. When signals are transmitted and received, the control board 220 can control the second switch 222 in a close state. The current corresponding to the power that is supplied in the second mode may be smaller than the current corresponding to the power that is supplied in the first mode. Accordingly, even though power is transmitted to the output terminal 230 through the second switch 222 of the control board 220, the problem that the size of the control board 220 is increased or heat is generated may not occur.

Further, when power is supplied in the second mode, the control board 220 can be activated by supplying the power to the control board 220, and the first switch 221 and the second switch 222 can be controlled by the activated control board 220.

However, when signals are transmitted and received, the control board 220 determines whether conditions are satisfied, and can control the second switch 222 based on the determination result. For example, the first connector 210 may have at least one recognition pin, which is connected to the supply cable 100 and recognizes a resistance value of the plug 110 disposed at the first end of the supply cable 100, of the plurality of connection pins. The control board 220 can be connected to the at least one recognition pin and can control the second switch 222 based on the resistance value of the plug 110 recognized through the recognition pin when power is supplied in the second mode.

In detail, the control board 220 can determine an allowable current of the plug 110 based on the resistance value of the plug 110 recognized when power is supplied in the second mode and an allowable voltage according to a pre-stored resistance value of the plug 110, and can control the second switch 222 by comparing a supply current corresponding to the supplied power and the allowable current of the plug 110. Data of the allowable voltage of the plug 110 according to pre-stored resistance values of the resistor 111 when the plug 110 has the resistor 111 may be as in the following Table 1. However, this is only an example, and of course, resistance values of the plug 110 and corresponding allowable voltage ranges are not limited to the values shown in the following Table 1.

TABLE 1

| | |
|---|---|
| Plug resistance | Allowable voltage range |

| No. | value | | MIN | MAX |
|---|---|---|---|---|
| 1 | 0Ω (short) | | 0.00 | 0.40 |
| 2 | 750Ω | | 0.50 | 0.90 |
| 3 | 1.5 | kΩ | 1.00 | 1.40 |
| 4 | 2.4 | kΩ | 1.50 | 1.90 |
| 5 | 3.9 | kΩ | 2.00 | 2.40 |
| 6 | 5.6 | kΩ | 2.50 | 2.90 |
| 7 | 8.2 | kΩ | 3.00 | 3.40 |
| 8 | 13 | kΩ | 3.50 | 3.90 |
| 9 | 27 | kΩ | 4.00 | 4.40 |

| | | | |
|---|---|---|---|
| 10 | OPEN | 4.50 | 5.00 |

In other words, the control board 220 can recognize the resistance value of the plug 110 of the supply cable 100 connected to the first connector 210 through the at least one recognition pin of the plurality of connection pins, and can determine a corresponding allowable voltage range based on the recognized resistance value. The control board 220 can recognize an allowable current using the recognized resistance value of the plug 110 and the determined allowable voltage range.

The control board 220 can determine a supply current corresponding to the power that is supplied when a power is supplied in the second mode and can control the second switch 222 by comparing the supply current with the allowable current of the plug 110. In order to compare the allowable current of the plug 110, the control board 220 may include at least one of a Current Transformer (CT) 223 and a Zero-phase Current Transformer (ZCT) 224 that measures a supply current corresponding to power that is supplied. The control board 220 according to an embodiment of the present disclosure may include both the CT 223 and the ZCT 224. The CT 223 and the ZCT 224 may be mounted on the control board 220 and may be disposed between the second switch 222 and a second power pin connected to the control board 220 of the plurality of connection pins of the first connector 210. Accordingly, the control board 220 can measure a supply current corresponding to power, which is supplied, through the CT 223 and the ZCT 224, and can control the second switch 222 to be maintained in the open state when the supply current exceeds the allowable current of the plug 110 by comparing the supply current and the allowable current of the plug 110. Since the second switch 222 is controlled to be maintained in the open state, it is possible to prevent an over-current from flowing to the control board 220 and a vehicle due to a supply current exceeding the allowable current.

When the supply current is less than the allowable current of the plug 110, the control board 220 can control the second switch 222 in a close state such that power that is supplied is transmitted to a vehicle through the output terminal 230 and the vehicle is charged.

Meanwhile, the control board 220 may further include a plurality of connectors other than the first connector 210. The control board 220 may include a second connector 225, a third connector 226, and a fourth connector 227, and the connectors may be connected to the plurality of connection pins of the first connector 210, respectively, or with the output terminal 230. For example, the second connector 225 may be disposed between the second switch 222 and the second power pin corresponding to the second mode of the plurality of connection pins of the first connector 210, and may connect the second power pin and the second switch 222 to each other. The third connector 226 may be disposed between the second switch 222 and the output terminal 230 and may connect the second switch 222 and the output terminal 230 to each other. Accordingly, when power is supplied in the second mode, the second connector 225 can perform an input function that receives power and the third connector 226 can perform an output function that outputs input power to the output terminal 230.

The fourth connector 227 may be connected to the connection pin, to which signals are input, of the plurality of connection pins of the first connector 210, and the control board 220 can perform control by determining signals input through the fourth connector 227. For example, the fourth connector 227 may be connected to a connection pin corresponding to the first mode of the plurality of connection pins of the first connector 210, a connection pin (TEMP) to which the temperature of the plug 110 is input, a connection pin (PLUG-OPTION) to which a specification such as a resistance value of the plug 110 is input, and a connection pin (GND) grounding both the connection pin (TEMP) to which temperature of the plug 110 is input and the connection pin (PLUG-OPTION) to which a specification of the plug 110 is input.

Meanwhile, referring to FIG. 2 again, the fourth connector 227 may be disposed between the connection pin, which recognizes signals, of the plurality of connection pins formed at the first connector 210 and the first terminal of the first switch 221. When power is supplied in the first mode, the control board 220 can determine whether a signal is input through the fourth connector 227, and when a signal is input, the control board 220 can control the transmission paths such that the input signal is transmitted to a vehicle through the output terminal 230 by controlling the first switch 221. Further, when power is supplied in the first mode, the supplied power is transmitted to the output terminal 230 without passing through the control board 220, whereby the control board 220 does not control the second switch 222 such that the second switch 222 is maintained in the open state.

According to the above description, the control box for charging 200 according to an embodiment of the present disclosure is connected to a plurality of supply cables according to external power sources and forms transmission paths for power and signals for a plurality of modes, thereby controlling charging of a vehicle. Accordingly, it is possible to increase compatibility according to a plurality of modes.

Although the present disclosure was provided above in relation to specific embodiments shown in the drawings, it is apparent to those having ordinary skill in the art that the present disclosure may be changed and modified in various ways without departing from the scope of the present disclosure, which is described in the following claims.

The present disclosure can be achieved as computer-readable codes in a program-recoded medium. A computer-readable medium includes all kinds of recording devices that keep data that can be read by a computer system. For example, the computer-readable medium may be a Hard Disk Drive (HDD), a Solid State Disk (SSD), a Silicon Disk Drive (SDD), a read-only memory (ROM), a random-access memory (RAM), a compact-disc ROM (CD-ROM), a magnetic tape, a floppy disk, and an optical data storage. Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

What is claimed is:

1. A control box for charging, comprising:
a first connector connected to a supply cable having a plug, which is connected to an external power source, at a first end, and having a plurality of connection pins; and
a control board including a first switch mounted therein and configured to:
control the first switch in a first state such that an input signal is transmitted to an output terminal of the control box for charging when power is supplied in a first mode in which a signal is input from the first connector, and
control the first switch in a second state to transmit and receive signals to and from a vehicle connected to the output terminal when power is supplied in a second mode in which a signal is not input from the first connector.

2. The control box of claim 1, further comprising an output cable connected to the output terminal and configured to output power and signals provided through the supply cable to the vehicle.

3. The control box of claim 1, wherein the first mode is a mode in which the plug of the supply cable is connected to a charging facility, and
the second mode is a mode in which the plug of the supply cable is connected to a system power source.

4. The control box of claim 1, wherein the first switch includes:
a first terminal connected to the first connector;
a second terminal connected to the control board; and
a third terminal connected to the output terminal.

5. The control box of claim 4, wherein the control board is configured to:
control the first switch in the first state in which the first terminal and the third terminal are connected to each other when power is supplied in the first mode in which the signal is input from the first connector; and
control the first switch in the second state in which the second terminal and the third terminal are connected to each other when power is supplied in the second mode in which the signal is not input from the first connector.

6. The control box of claim 1, wherein when power is supplied in the first mode, at least one first power pin corresponding to the first mode of the plurality of connection pins of the first connector is directly connected to the output terminal.

7. The control box of claim 1, wherein when power is supplied in the second mode, at least one second power pin corresponding to the second mode of the plurality of connection pins of the first connector is connected to the control board, and
the control board further includes a second switch connected to the at least one second power pin and the output terminal at both ends, respectively.

8. The control box of claim 7, wherein when power is supplied in the second mode, the control board is configured to:
control the second switch in an open state until a signal is input from the vehicle by controlling the first switch in the second state, and
control the second switch in a close state when a signal is input from the vehicle.

9. The control box of claim 8, wherein the first connector includes at least one recognition pin connected to the supply cable and configured to recognize resistance of the plug of the plurality of connection pins, and
when the control board is connected to at least one connection pin among the plurality of connection pins and is supplied with power in the second mode, the control board is configured to control the second switch based on the recognized resistance of the plug.

10. The control box of claim 9, wherein when power is supplied in the second mode, the control board is configured to:
determine an allowable current of the plug based on a determined voltage according to the recognized resistance of the plug and a pre-stored resistance of the plug, and
control the second switch in the open state when a supply current corresponding to power that is supplied exceeds the allowable current of the plug.

11. The control box of claim 10, wherein the control board includes at least one of a current transformer and a zero-phase current transformer that are configured to measure a supply current corresponding to power that is supplied.

12. The control box of claim 7, wherein the control board includes:
a second connector disposed of between the second power pin and the second switch; and
a third connector disposed of between the second switch and the output terminal.
